(19) United States
(12) Patent Application Publication
(10) Pub. No.: US 2013/0200170 A1
(43) Pub. Date: Aug. 8, 2013

(54) Gas Dispersion Plate for Plasma Reactor Having Extended Lifetime

(71) Applicant: Green, Tweed of Delaware, Inc., Wilmington, DE (US)

(72) Inventors: Curtis Marx, Macungie, PA (US); Jose Luis Gonzalez, San Lorenzo, CA (US); Giovanni Foggiato, Morgan Hill, CA (US); Barry Kitazumi, Milpitas, CA (US)

(73) Assignee: GREENE, TWEED OF DELAWARE, INC., Wilmington, DE (US)

(21) Appl. No.: 13/758,619

(22) Filed: Feb. 4, 2013

Related U.S. Application Data
(60) Provisional application No. 61/594,200, filed on Feb. 2, 2012.
(60) Provisional application No. 61/598,525, filed on Feb. 14, 2012.

(51) Int. Cl. B05B 17/00

(52) U.S. Cl. CPC B05B 17/00
USPC 239/1; 239/548

(57) ABSTRACT

The invention includes a gas dispersion plate to provide reactant gases to a reaction chamber comprising: a plate body having a first surface and a second surface, the plate body having at least one injection passage that spans the plate from the first surface to the second surface, the distance along the passage from the first surface to the second surface defining the length of the passage, wherein the injection passage includes an ion trap chamber, through which gas flows from the first surface of the plate to the second surface of the plate. In an embodiment, the passage includes an inlet portion interposed between the first surface and the chamber and an outlet portion that is interposed between the ion trap chamber and the second surface.

### CROSS REFERENCE TO RELATED APPLICATION

This application claims the benefit under 35 U.S.C. §119(e) to U.S. Provisional Patent Application No. 61/594,200, filed Feb. 2, 2012; and to U.S. Provisional Patent Application No. 61/598,525, filed Feb. 14, 2012; the entire disclosures of each of which are incorporated herein by reference.

### BACKGROUND OF THE INVENTION

Etching is used in various micro fabrication processes, including semiconductor device fabrication, to chemically remove layers from the surface of a semiconductor wafer during manufacturing. Etching is an important process step, and wafers with associated semiconductor device layers undergo many etching steps before manufacturing is completed. Because of the significance of this step to fabrication of a usable end product, it is important that the etching processes and equipment are well maintained and controlled. For some processes, the etching step is carried out using gas plasmas. While the high reactivity of the gas plasmas makes them well suited to the etching process, the plasmas' propensity to reactivity also makes control and confinement of the plasmas challenging, as the ionizing reactants tend to react with and/or degrade any material with which they come in contact.

For example, to supply the reactants to the reaction chamber (where wafer etching takes place), one passes the reactant gases through a gas dispersion plate (“GDP”) or (as is commonly known, a showerhead), to inject the gas into the reaction chamber, while controlling the gas flow and distribution. In the gas dispersion plate there exists an array of holes that allow injection of the gas into the process chamber.

In has been recognized that, when such hole configurations are used for providing reactant gases for semiconductor etching, the reactant ions within the process chamber may backflow into the hole(s) and etch the inside wall of the hole(s), enlarging its/their size. Over time, this enlargement leads to a modification of the gas flows into and within the reaction chamber. Such gas flow changes result in non-uniform etching of the semiconductor wafer surface. These non-uniformities directly affect the realizable yield of integrated circuits obtainable from the wafer, decreasing the overall yield of the process and increasing production costs.

Another problem manifests itself when reactant ions reach a chamber that interfaces with the a cooling plate of the gas dispersion plate typically made of metal. The reactant ions are electrically charged and upon reaching the metal cooling plate, will electrically connect the plasma to the plate causing arcing. Such arcing results in an “electrical shorting” of the plasma to the metal plate and also affects the etching uniformity. Both the etching of the inside walls and the electrical shorting cause particles to be formed, with such particles dispersed onto the wafer surface. These particles will introduce electrical and physical defects on the integrated circuits being made from the wafer, also affecting yield.

There remains a need in the art to suppress the ability of the reactant ions of the plasmas to penetrate into the GDP hole(s) or, if an ion does penetrate, to reduce or eliminate the ions' ability to reach the metallic cooling plate of the gas dispersion plate.

### BRIEF SUMMARY OF THE INVENTION

The invention includes a gas dispersion plate to provide reactant gases to a reaction chamber comprising: a plate body having a first surface and a second surface, the plate body having at least one injection passage that spans the plate from the first surface to the second surface, the distance along the passage from the first surface to the second surface defining the length of the passage, wherein the injection passage includes an ion trap chamber, through which gas flows from the first surface of the plate to the second surface of the plate. In an embodiment, the passage includes an inlet portion interposed between the first surface and the chamber and an outlet portion that is interposed between the ion trap chamber and the second surface.

Also included are related methods.

### BRIEF DESCRIPTION OF THE DRAWINGS

The foregoing summary may be better understood when read in conjunction with the appended drawings. It should be understood that the invention is not limited to the precise arrangements and instrumentalities shown. In the drawings:

FIG. 1 is a schematic representation of a transverse section of a prior art GDP having two injection passages;

FIG. 2 is a schematic representation of a transverse section of a prior art GDP including a metallic cooling plate illustrating potential ion bombardment and etching of the inside of holes and corners;

FIG. 3 is a schematic representation of a GDP of the invention (transverse section) showing the ion trap with inlet portion of the injection passage being coaxial and the outlet portion of the passage being coaxial to one another and to the chamber;

FIG. 4a is a schematic representation of the GDP of the invention (transverse section) wherein an individual injection passage has two inlet portions and a single outlet portion having multiple holes for the gases to be injected into the reaction chamber. FIG. 4b shows the converse arrangement;

FIG. 5 is a schematic representation of the GDP of the invention (transverse section) wherein a hypothetical vertical axis through the inlet portion of the injection passage is offset relative to a hypothetical vertical axis through the outlet portion of the injection passage, In FIG. 5, only a cell plate (of the plate body) is shown and it is show as a two piece part. However, one could prepare this exemplary cell plate and other cell plate of the invention as a unitary piece;

FIG. 6 is a schematic representation of the GDP of the invention (transverse section) where the inlet portion of the injection passage is angled with an acute angle (<ₐ) and an obtuse angle (<ₒ) and offset in alignment to eliminate the direct line from the plasma chamber to the cooling plate; and

FIG. 7 is an alternative schematic representation of the GDP of the invention (transverse section) where each of the inlet portion and the outlet portion of the injection passage is displaced in alignment and angled to eliminate the direct line from the plasma chamber to the cooling plate.

### DETAILED DESCRIPTION OF THE INVENTION

The invention includes a gas dispersion plate (GDP) to provide reactant gases to a reaction chamber, methods of increasing lifetime of a GDP used to provide reactant gases to a reaction chamber, and methods of reducing the degradation of an injection passage in a GDP used to provide reactant gases to a reaction chamber, and of preventing reactive ions from reaching the metal cooling plate thereby reducing particulate generation or dispersion onto the wafer being processed.

In one embodiment, the invention is used to provide reactant gases to a reaction chamber in which semiconductor wafers are etched. However, the invention can be used in any circumstances where a reactant gas must be provided to a chamber (in semiconductor processing or other applications) including, without limitation, in semiconductor equipment that uses plasmas for other types of processing, such as stripping of photo resist, chemical vapor deposition or cleaning of semiconductor wafers, sterilization, cleaning of metallic or plastic

parts, and surface modification equipment applicable to metallic and plastic parts, such as equipment used for residual gas analysis.

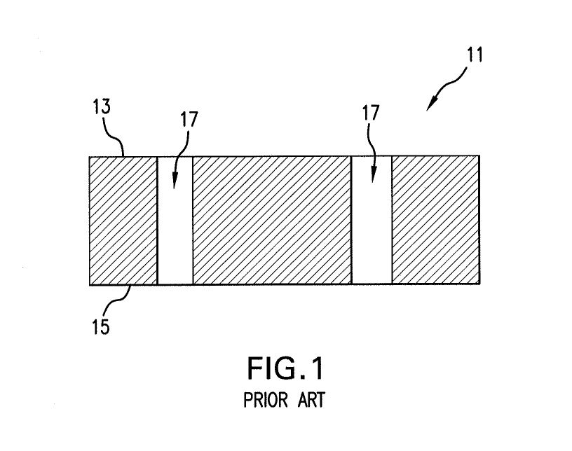

In conventional GDPs, the injection passages are engineered to pass through the plate body 11 from the plate body's first surface to the plate body's second surface providing a substantially straight and direct pathway for the gases to flow. FIG. 1 shows a transverse section of a conventional plate. In longitudinal cross section FIG. 1 illustrates typical injection passages in a gas dispersion head. The injection passages have an inlet, through which gas is injected and terminate in a outlet, where the injected gas exits into the reaction chamber. Conventionally, the passages have a uniform diameter of about 0.5 mm and the thickness of the plate may be about 25 mm (1 inch). The typical materials for this cell plate may be silicon, silicon carbide, and others.

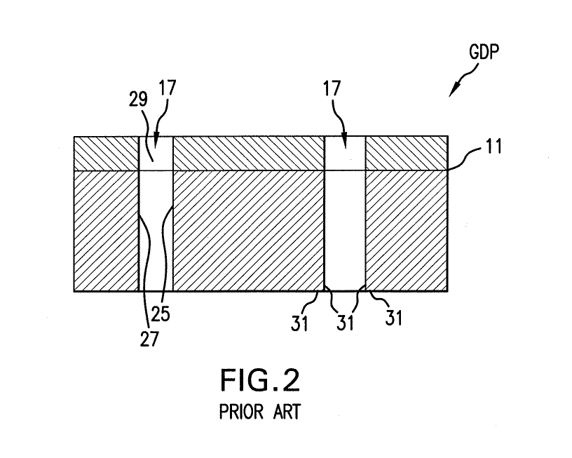

FIG. 2 shows the paths of various ions penetrating into the injection passage 17 in a prior art configured gas dispersion plate 19, which includes a cell plate 23 and a cooling plate 21. The cooling plate 21 serves to keep the nonmetallic portion (cell plate 23) of the GDP 19 cool because the plasma heats up the cell plate 23. As is schematically illustrated in FIG. 2 by the arrows, the reactive ions may each “backflow” through the outlet and the sidewalls of the injection passage even in the presence of the cooling head, causing etching and enlarging the holes' size and affecting the gas flow dynamics as gas flows through the injection passage(s).

This etching can generate particles that may become directly in contact with the wafer surface. These particles may result in defects on the wafer surface, greatly affecting the resultant yield of good integrated circuits. In some cases, the reactant gas ions backflow far enough to reach the entry of the inlet where may exist an interface to a metal cooling plate. As the plate's electrical potential is much lower than that of the plasma, there is an “electrical shorting” of the plasma to the cooling plate. The latter phenomenon affects the ion density present in the vicinity of the injection outlet and the plasma reaction on the wafer, leading to non-uniform etching at the surface of the wafer. As with the wall etching of the injection passages, this “shorting” will also generate particles, also brought down onto the wafer surface.

It has been discovered by the inventors that the design of an injection passage may be engineered to allow the space charge of the reactive ions to expand the size of the ion beam coming into the outlet. A gas traveling toward the outlet portion of the injection passage (and toward the reaction chamber), will randomly inject traveling reactive ions back up into the passage as depicted in FIG. 2. The ion beam with its space charge will expand its size as it travels through the passage and may be absorbed by the sidewalls of the passage. It has been recognized by the inventors that if the GDP can be configured to suppress the activity of the “cooling plate ions” 25 and the “perpendicular ions” 29 (and collaterally, to some degree, the activity of the “sidewall ions” 27), the negative effects of the etching can be ameliorated or eliminated.

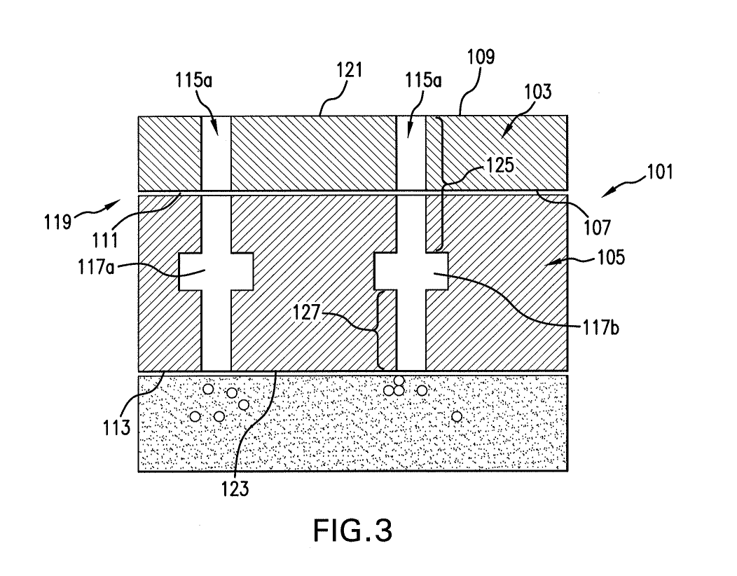

By engineering the passage to include at least one ion trap chamber as depicted in, for example, FIG. 3, (that is, by enlarging a sub-portion of the passage, relative to the passage), the inventors have discovered that the rate of expansion of the ion beam can be ‘forced’ to increase rapidly, thus trapping reactive ions within the ion trap chamber. The ions are sequestered in the trap and prevented from exercising any degradation action on the interior walls of the injection passage, and prevented from reaching the metallic cooling plate.

FIG. 3 schematically illustrates the implementation of the ion trap within the cell plate. In FIG. 3, the GDP 101 includes a cooling plate 103 and a cell plate 105, both of which are shown in transverse section. The cooling plate contains a first surface 107 and a second surface 109. The cell plate also includes a first surface 111 and a second surface 113. Injection passages 115a, 115b span the plate body 117 (which, in FIG. 3, includes both a cell plate 105 and a cooling plate 103). The injection passages include an ion trap chamber 117a, 117b. The ion trap chamber may be located at approximately the mid-point of the injection passage (as shown in FIG. 3) or it may be on either side of the mid-point, e.g., closer to the reaction chamber or closer to the gas source. FIG. 3 schematically illustrates the implementation of the ion trap chamber 117a, 117b. The ions present in the reaction chamber migrate towards the cooling plate 103. As the injection passages 115a, 115b are entered, restriction of the ion cloud in the injection passages is disrupted by the ion trap chamber 117a, 117b. Once the ion cloud reaches the ion trap chamber 117a, 117b, the ion cloud rapidly expands and the ions are confined within the trap, unable to travel forward or backward in the passage. The electric fields that propel the ions through the passages, including the repulsive forces between and among the ions, are rendered non-uniform in the space of the ion trap, further confining the ions in the trap.

Additionally, the inclusion of at least one ion trap chamber serves to reduce and/or eliminate arcing by preventing the reactant ions from reaching the inlet portion of the passage and reaching the metallic cooling plate, which, if made of a material like aluminum, would have resulted in an arcing phenomena and generation of particles.

The plate body of the invention may be made of one piece or may comprise several plates or pieces layered or otherwise arranged together. In some embodiments, it may be preferred that the plate body comprises a cell plate and a cooling plate. The cell plate of the plate body (as well as and/or any other components of the GDP) may be made of any materials that are resistant to etchant gases and/or corrosive or reactive chemicals, depending on the end use(s) of the GDP. However, in certain applications it may be preferred that the cell plate of the plate body is made of silicon. If it is to be used to provide etching gases to a reactant chamber for semiconductor processing, it may be desired that the selected materials are resistant to etching gases and/or able to provide the upper electrode for the radio frequency power that ignites the plasma within the reactor and sustains it during the etching cycle.

The plate body (as well as and/or any other components of the GDP, including the cell plate or the cooling plate) may be made of one selected material, or may be made of a first material upon which one or more layers or films of alternative materials may be placed, for example, to increase etch resistance. Suitable materials for either may include, without limitation, silicon, silicon carbide, yttria, YAG, aluminum oxide nitride, aluminum nitride, sapphire, and other etch resistant materials. In one embodiment, the plate body may be made of silicon. In another, it may be made of silicon coated with yttria.

In most embodiments, it may be preferred that the cooling plate is metallic, either formed of a metal and/or a substrate coated with a metallic layer(s).

In some embodiments, it may be preferred that the GDP is a dual, triple, or more than three-piece gas dispersion plate, which may include, for example, a cell plate (containing the at least one injection passage(s)), a gas entry plate, a cooling plate, a face plate, and/or other plates as desired. Moreover, in some embodiments, the plate body itself as described below is formed from two or more plates or components integrated together.

The plate body may be any thickness, including for example, plate thicknesses of about 5 to about 10 mm or up to about 25 mm.

Referencing FIG. 3, in an embodiment, the plate body 119 of the invention may include at least one injection passage 117a, 117b that spans the plate body's transverse plane from the first surface 121 of the plate body to the second surface 123 of the plate body. The distance along the passage from the first surface to the second surface defines the length of the injection passage. The injection passage includes an inlet portion 125 that extends a distance from the first surface 124 of the plate body 119 and an outlet portion 127 that extends a distance from the second surface 123 of the plate body.

In an embodiment, the sidewall of the injection passage 115a, 115b has a substantially circular cross section, although injection passages having other cross-sectional shapes may be used as well.

The injection passage 115a, 115b includes at least one ion trap chamber 117a, 117b. When viewed in cross section, the shape formed by the sidewalls of ion trap chamber (“S_{c}”) has a perimeter that is greater than the perimeter of the shape formed by the sidewalls of the injection passage when viewed in cross section that is substantially adjacent to the ion trap chamber (“Sₚ”). The magnitude of difference between the perimeters of S_{c} and of Sₚ may vary, depending on the end use application of the GDP. However, in some embodiments, it may be preferred that the perimeter of Sₚ is about 0.1%, about 0.5%, about 1%, about 5%, about 10%, about 15%, about 20%, about 25%, about 30%, about 35%, about 40%, about 45%, and about 50% or less of the perimeter of S_{c}.

In some embodiments, S_{c} is in the shape of a polygon, such a square, rectangle, or hexagon although any shape may be selected. For example, S_{c} may have the shape of a uniform polygon, a non-uniform polygon, a triangle, a circle and ellipse, an ovate, a diamond, an ovate, a parallelogram, a rhombus, pentagon, octagon, heptagon, and hexagon. In some embodiments, the space defined by the ion trap chamber is in the form of a complex geometric solid, such as, for example, a 4-faced, 8-faced, 12-faced or 20-faced geometric solid, so that any set of S_{c}s taken from the chamber may be in the form of varying shapes.

The relative length along the transverse axis of the injection passage, L_{c}, as compared to that of the ion trap chamber may be any dimension, and will necessarily vary depending on, for example, the end application for the GDP, the number of ion trap chambers included, the operating RF and Bias powers for the plasma, the plasma density being used and/or the reactant gases selected for the application. In some embodiments, the transverse distance of the chamber, as measured from the chamber inlet to the chamber outlet, may be, without limitation, about 5%, about 10%, about 15%, about 20%, about 25%, about 30%, about 35%, about 40%, about 45%, and about 50% of the length of the injection passage.

In an embodiment, the ion trap chamber is interposed between the first surface of the plate body and the outlet portion of the injection passage or is interposed between the second surface and the inlet portion of the plate body. It may be preferred that the ion trap chamber is interposed between both the inlet portion of the passage and the outlet portion of the passage. It may be preferred that the chamber(s) is coaxial with the injection passage. However, in some embodiments the chamber may be offset from the passage, that is, its axis may be parallel to but not coaxial with the axis of the passage. This eliminates a direct path for the ions coming from the reaction chamber to penetrate to the metallic cooling plate

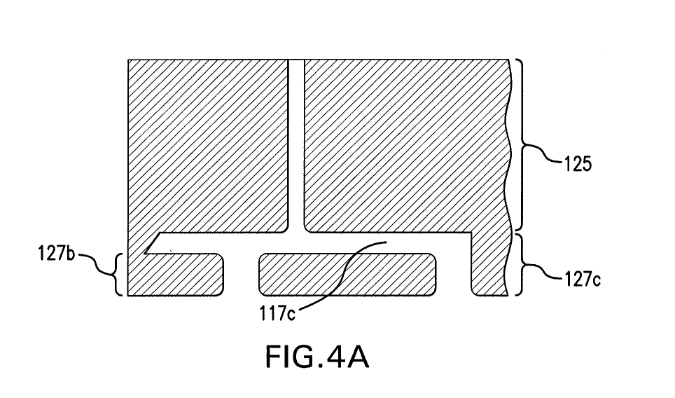

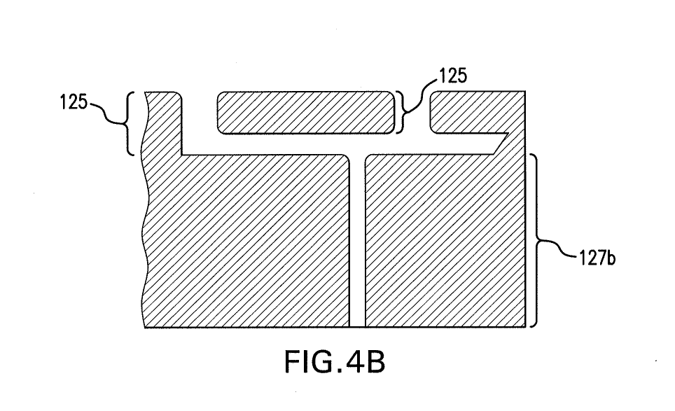

Referencing FIG. 4a and b, the plate body may include one inlet portion, at least one ion trap chamber, and two or more outlet portions, whereby the gas enters into the injection passage via the inlet portion and is egressed into the reaction chamber via at least one or more outlet portions, or the converse may be true. In these embodiments, the perimeter of S_{c} is greater than each of Sₚᵢ and Sₚₒ, where Sₚᵢ is a shape formed by the cross section of the passage at the inlet portions, and Sₚᵢ is the shape formed by the cross section of the passage at the inlet of the ion trap, or the converse.

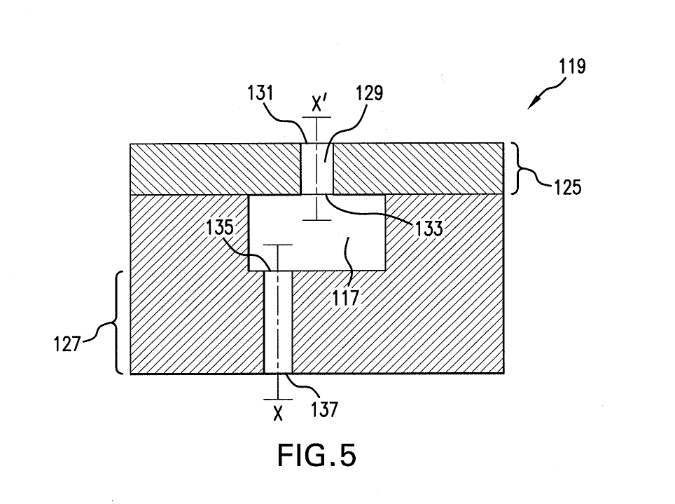

Referencing FIG. 5, an embodiment of the invention includes a plate body 119 having at least one offset injection passage 129, that is, an injection passage that includes at least three portions, at least two of which are from one another. For example, as shown in FIG. 5, the offset injection passage 129 may include three portions: an inlet portion 125, an ion trap portion 117, and an outlet portion 127. The inlet portion 125 is that portion of the injection passage 129 spanning from the inlet 131 to the ion trap. Inlet 133 the outlet portion 127 of the injection passage is that which spans from the outlet 137 to the ion trap chamber outlet 135. Each of the inlet portion 125 and the outlet portion 127 of the offset injection passage 129 has a hypothetical axis X and X₁. In this embodiment, the axis X and X₁, are offset; that is, they are parallel but not co-axial, to one another.

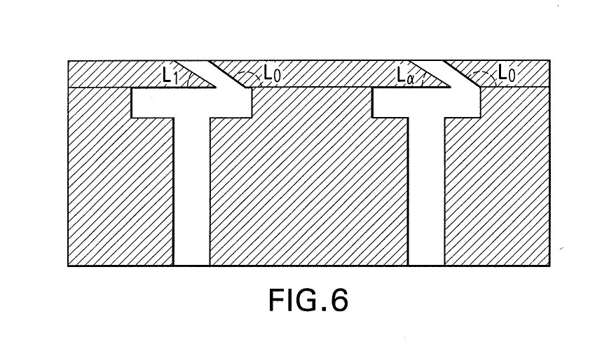

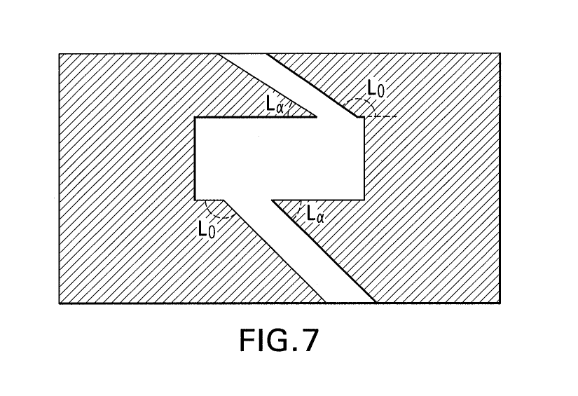

In an additional embodiment, exemplified in FIG. 6, the hypothetical axes X and X, may be offset and/or be situated non-parallel relative to one another. In such embodiment, the inlet position and/or outlet portion, such that a hypothetical axis X and X₁ of the inlet portion or the outlet portion intersect a hypothetical horizontal plane h taken through the plate body to form an angle A of about 10 to about 60 degrees, about 20 to about 50 degree and about 30 to about 40 degrees.

Whereas the Figures illustrate passages and ion trap chamber, having circular cross-sections.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A gas dispersion plate (GDP) to provide gases to a reaction chamber comprising: a plate body having a first surface and a second surface, the plate body having at least one injection passage that spans the plate body from the first surface to the second surface, the distance along the injection passage from the first surface to the second surface defining the length of the injection passage, wherein the injection passage includes an ion trap chamber.

2. The GDP of claim 1, wherein the plate body comprises a cooling plate and a cell plate, and a first surface of the cell plate faces a first surface of the cooling plate.

3. The GDP of claim 1, wherein the injection passage includes an inlet portion interposed between the first surface and the ion trap chamber.

4. The GDP of claim 1, wherein the injection passage includes an outlet portion interposed between the ion trap chamber and the second surface.

5. The GDP of claim 3, wherein the injection passage includes two or more outlet portions.

6. The GDP of claim 2, wherein the injection passage includes two or more inlet portions.

7. The GDP of claim 1, wherein the passage has a cross section that is generally circular.

8. The GDP of claim 1, wherein the passage includes two or more ion trap chambers.

9. The GDP of claim 1, wherein the chamber has a chamber inlet and a chamber outlet, and the distance from the ion trap chamber inlet and the ion trap chamber outlet is at least about 5% of the length of the passage.

10. The GDP of claim 1, wherein the ion trap chamber has an ion trap chamber inlet and an ion trap chamber outlet, and the distance from the chamber inlet to the chamber outlet is one of about 5%, about 10%, about 15%, about 20%, about 25%, about 30%, about 35%, about 40%, about 45%, and about 50% of the length of the passage.

11. The GDP of claim 1, wherein the shape formed by a cross section of the ion trap chamber is a square.

12. The GDP of claim 1, wherein the shape formed by a cross section of the ion trap chamber is a polygon.

13. The GDP of claim 1, wherein the shape formed by a cross section of the ion trap chamber is a non-uniform polygon.

14. The GDP of claim 1, wherein the shape formed by a cross section of the ion trap chamber is selected from a circle, an ellipse, a diamond, an ovate, a parallelogram, a rhombus, and a non-uniform polygon.

15. The GDP of claim 1, wherein the injection passage is defined by at least one sidewall that comprises a material selected from silicon, silicon carbide, yttria, YAG, aluminum oxide nitride, aluminum nitride, and sapphire.

16. The GDP of claim 1, wherein the ion trap chamber is defined by at least one sidewall a material selected from silicon, silicon carbide, yttria, YAG, aluminum oxide nitride, aluminum nitride, and sapphire.

17. The GDP of claim 1, wherein the ion trap chamber is coaxial with the injection passage.

18. The GDP of claim 1, wherein the injection passage includes an inlet portion and an outlet portion.

19. The GDP of claim 18, wherein a hypothetical vertical axis (x) of a transverse section of the inlet portion is offset relative to a hypothetical vertical axis (x′) of a transverse section of the outlet portion.

20. A method of extending the useful lifetime of a gas dispersion plate comprising preparing a gas dispersion plate comprising a plate body having a first surface and a second surface, the plate body having at least one injection passage that spans the plate from the first surface to the second surface, the distance along the passage from the first surface to the second surface defining the length of the passage, wherein the injection passage includes an ion trap chamber.

21. A method of reducing the degradation of an injection passage in a gas dispersion plate, the method comprising preparing a gas dispersion plate comprising a plate body having a first surface and a second surface, the plate body having at least one injection passage that spans the plate from the first surface to the second surface, the distance along the passage from the first surface to the second surface defining the length of the passage, wherein the injection passage includes an ion trap chamber, whereby a gas can flow from the first surface of the plate to the second surface of the plate and the plate body comprising a cooling plate and a cell plate, and a first surface of the cell plate faces the reaction chamber and a second surface of the cell plate faces a first surface of the cooling plate.

22. A method of reducing the electrical connection of the reaction chamber plasma to gas dispersion plate, the gas dispersion plate comprising a interfacing the non-metallic dispersion plate, the method comprising preparing a plate comprising a plate body having a first surface and a second surface, the plate body having at least one injection passage that spans the plate from the first surface to the second surface, the distance along the passage from the first surface to the second surface defining the length of the passage, wherein the injection passage includes an ion trap chamber, whereby a gas can flow from the first surface of the plate to the second surface of the plate.

23. A method of reducing the particle generation to reduce particles deposited onto the wafer, the method comprising preparing a plate comprising a plate body having a first surface and a second surface, the plate body having at least one injection passage that spans the plate from the first surface to the second surface, the distance along the passage from the first surface to the second surface defining the length of the passage, wherein the injection passage includes an ion trap chamber, whereby a gas can flow from the first surface of the plate to the second surface of the plate.

24. A method of preventing electrical contact of a reactant ion with a surface of a cooling plate in a gas dispersion head comprising preparing a gas dispersion plate, wherein the gas dispersion plate comprises a plate body having a first surface and a second surface, the plate body having at least one injection passage that spans the plate from the first surface defining the length of the passage, wherein the injection passage includes an ion trap chamber and wherein the plate body comprises a cooling plate and a cell plate, and a first surface of the cell plate faces the reaction chamber and a second surface of the cell plate faces a first surface of the cooling plate.

25-41. (canceled)
